(19) United States
(12) Patent Application Publication
(10) Pub. No.: US 2006/0037040 A1
(43) Pub. Date: Feb. 16, 2006

(54) Method of transmitting audio and video signals over radio and television channels

(76) Inventors: Scott G. Mahalick, Las Vegas, NV (US); Mark D. Allen, Richardson, TX (US)

Correspondence Address: Kirk D. Houser;Eckert Seamans Cherin & Mellott, LLC, 44th Floor, 600 Grant Street, Pittsburgh, PA, 15219, US

(21) Appl. No.: 10/916,775

(22) Filed: Aug. 12, 2004

(51) Int. Cl. H04N 7/10; H04N 5/445; H04N 7/173

(52) U.S. Cl. 725/32; 725/135; 725/117; 725/146; 725/42

(57) ABSTRACT

A method of transmitting audio and video signals includes transmitting an audio signal from one or more prerecorded audio/video sources, such as music videos, news/talk radio station programs or interview programs, over a radio channel; and with respect to the transmitting of the audio signal, contemporaneously transmitting the audio signal and a video signal from the one or more prerecorded audio/video sources over a television channel.

### BACKGROUND OF THE INVENTION

1. Field of the Invention

This invention pertains generally to transmitting audio and video signals and, more particularly, to methods of radio and television transmission, such as radio broadcasts and television broadcasts.

2. Background Information

It is known for a radio station (e.g., most AM and FM radio stations) to broadcast an audio signal from one or more music sources over a radio channel.

It is also known for a television station (e.g., MTV; VH1) to broadcast audio and video signals from music videos over a television channel.

It is further known to “simulcast” over radio and television channels (e.g., Imus in the Morning; a concert shown over television and simulcast over FM radio). For example, U.S. Pat. No. 5,440,351 discloses a television set with an integrated radio tuner, such that simulcast radio broadcasts may be played through a television sound system at the viewer's discretion. A user-programmable memory provides the viewer with the ability to store multiple television channel/radio frequency associations. A remote control device provides the viewer with the capability of selecting through a TV/Radio button either normal television audio or radio simulcast sound.

It is known to provide a manually controlled mixing and switching board for audio or video production or broadcast systems. These boards employ a relatively large number of available inputs or sources, multiple outputs and options for each source. It is also known to fully automate a station by having a computer replace the operators and oversee the entire operation of the station. See, for example, U.S. Pat. No. 6,101,324.

In addition to broadcast and cable television, hotels and motels often have video services systems that offer pay-per-view and video-on-demand services, as well as a variety of interactive services. Pay-per-view services are scheduled movie services that generally utilize a suitable storage medium (e.g., analog video cassette players; DVD players) installed in a remote location within the facility. The storage medium is preloaded with selected videos to be broadcast at predetermined, or scheduled, times. The programming can be accessed by multiple television sets (TVs) at any given time while the transmission is in progress.

It is also known to provide video-on-demand services that enable customers to select a program to be viewed at their convenience. Viewing times are not prescheduled and customers are given a choice of a relatively large number of programming alternatives. The selected programming is usually transmitted in such a manner that only the customer that selected the programming is able to receive the broadcast. Alternatively, some video-on-demand systems provide “join-in-progress” capability, such that other customers also may view the selected programming. As with pay-per-view, the programming is stored on a suitable storage medium. See, for example, U.S. Pat. Nos. 5,130,792; 5,729,279; and 5,818,512.

Cable television systems, sometimes referred to as community-antenna television (CATV) systems, are broadband communications networks of coaxial cable and optical fiber that distribute video, audio and data signals to the homes or businesses of subscribers. In a typical CATV system, a single advantageously located antenna array feeding a cable network supplies each individual subscriber with a usable television signal. A typical CATV system for the delivery of television programming to subscribers comprises three main elements: a headend, a distribution system and subscriber drops.

The “headend” is a signal reception and processing center that collects, organizes and distributes signals. The headend receives satellite-delivered video and audio programming, over-the-air broadcast television station signals, and network feeds delivered by terrestrial microwave and other communication systems. In addition, headends may inject local broadcast programming into the package of signals sent to subscribers, such as commercials and live programs created in a television studio.

The “distribution system” carries the signals from the headend to a number of distribution points in a community and, in turn, distributes these signals to individual neighborhoods for delivery to subscribers. A modern distribution system typically comprises a combination of coaxial cable and optical fibers, with trunk amplifiers periodically spaced to compensate for attenuation of the signals along the line.

“Subscriber drops” are taps in the distribution system that feed individual coaxial cable lines into subscribers' television sets or subscriber set-top terminals or set-top boxes (STBs), often referred to as “subscriber premises equipment” or “customer premises equipment” (“CPE”).

CATV distribution systems were originally designed to distribute television signals in the “downstream” direction only (i.e., from a central headend location to multiple subscriber locations, also referred to as the “forward” path). For downstream transmissions, typical CATV systems provide a series of video channels, each 6 MHz in bandwidth, which are frequency division multiplexed across the forward band, in the 50 MHz to 550 MHz region of the frequency spectrum. As optical fiber more deeply penetrates the service areas with hybrid optical fiber/coaxial cable (HFC) configurations, the bandwidth of the coaxial cable portion is expected to increase to over 1 GHz, thereby increasing the number of available channels for potential services.

The advent of pay-per-view services and other interactive television applications has fueled the development of bi-directional or “two-way” cable systems that also provide for the transmission of signals from the subscriber locations back to the headend via an “upstream” direction or a “reverse” path. By upgrading CATV systems employing relatively limited bandwidth coaxial cable with broadband distribution networks having HFC configurations, multiple service operators (MSOs) can use the additional channels gained by this wider bandwidth network to provide many new subscriber services. This ever-expanding deployment of fiber optic technology supports the implementation of an “interactive network” to allow a subscriber to obtain desired services or programming at a time and date specified by the subscriber. Indeed, it is feasible that this interactive network will have sufficient bandwidth to supply hundreds of channels of programming information, thereby leading to an explosion of program options available to subscribers. Potential subscriber services supported by this interactive network include movies-on-demand (MOD) or video-on-demand (VOD), interactive computing, shopping, entertainment and other related services. See, for example, U.S. Pat. No. 5,687,331.

There is room for improvement in methods of transmitting audio and video signals over radio and television channels.

### SUMMARY OF THE INVENTION

These needs and others are met by the invention, which provides a method whereby an audio signal is transmitted from one or more prerecorded audio/video sources, such as music videos, over a radio channel; and the audio signal and a video signal from the prerecorded audio/video sources are contemporaneously transmitted, or are transmitted on a delayed basis, through, for example, pay-per-view or video-on-demand, over a television channel.

In accordance with one aspect of the invention, a method of transmitting audio and video signals comprises: transmitting an audio signal from at least one music video over a radio channel; and with respect to the transmitting an audio signal, contemporaneously transmitting the audio signal and a video signal from the at least one music video over a television channel.

The method may transmit an audio advertisement over the radio channel; and contemporaneously transmit an audio and video advertisement over the television channel.

The method may employ substantially identical audio portions of the audio advertisement and the audio and video advertisement.

The method may employ as the video advertisement a first video commercial; employ a second different video commercial; direct the first video commercial to a first zip code; and direct the second different video commercial to a second different zip code.

The method may originate the audio signal and the video signal from a radio station; receive a live video signal at the radio station; temporarily include a window in the video signal of the television channel; and include the live video signal in the window.

The method may originate the audio signal and the video signal from a radio station; receive a digital photograph at the radio station; temporarily include a window in the video signal of the television channel; and include the digital photograph in the window.

As another aspect of the invention, a method of transmitting audio and video signals comprises: transmitting an audio signal from at least one prerecorded audio/video source over a radio channel; and with respect to the transmitting an audio signal, contemporaneously transmitting the audio signal and a video signal from the at least one prerecorded audio/video source over a television channel.

As another aspect of the invention, a method of transmitting audio and video signals comprises: recording audio and video signals from at least one audio/video source; transmitting an audio signal from the recorded audio and video signals over a radio channel; and with respect to the transmitting an audio signal, transmitting the audio signal and a video signal from the recorded audio and video signals on a contemporaneous or delayed basis from the recorded audio and video signals over a television channel.

### BRIEF DESCRIPTION OF THE DRAWINGS

A full understanding of the invention can be gained from the following description of the preferred embodiments when read in conjunction with the accompanying drawings in which:

FIGS. 1A-1B form a block diagram of a radio station including a radio channel broadcast and a contemporaneous cable television channel broadcast in accordance with the invention.

FIG. 2 is a block diagram showing an audio advertisement on the radio channel of FIG. 1A being supplemented by a contemporaneous video and/or audio advertisement on the television channel.

FIG. 3 is a block diagram showing an audio advertisement for the radio channel of FIG. 1A being supplemented by a non-simulcast television audio and/or video advertisement for the television channel of FIG. 1B.

FIG. 4 is a block diagram showing remote video and/or audio feeds from a remote location through a local cable television cable pipeline and a channel from the cable upstream providing the remote feeds to the radio station mixer of FIG. 1A.

FIG. 5 is a block diagram of a cable television system in which different contemporaneous television advertisements are directed to one or more selected zip codes through addressable set top boxes.

FIG. 6 is a block diagram of a system including a direct response interface that permits a cable television channel viewer to purchase CDs or DVDs on the cable or through a secondary wireless data device.

FIG. 7 is a block diagram of a system including a direct response interface that permits a cable television channel viewer to purchase and view on the cable or through a secondary wireless data device delayed video-on-demand and/or pay-per-view services, based upon previous radio channel audio broadcasts.

FIG. 8 is a block diagram of a television display including a video signal from a video source, such as a music video, and a window including a live video signal.

FIG. 9 is a block diagram of a television display including a video signal from a video source, such as a music video, and a window including a digital photograph from a listener/viewer of the television channel of FIG. 1B.

FIG. 10 is a block diagram of a television display including a video signal from a video source, such as a talk show video, and a window including a live stream from a listener/viewer of the television channel of FIG. 1B.

### DESCRIPTION OF THE PREFERRED EMBODIMENTS

As employed herein, the term “transmitting” shall expressly include, but not be limited by, broadcasting a signal, or sending a signal through a wireless or wired communication channel.

As employed herein, the term “broadcasting” shall expressly include, but not be limited by, transmitting by means of a radio channel or transmitting by means of a television channel.

As employed herein, the term “audio signal” shall expressly include, but not be limited by, any analog and/or digital representation of a plurality of sounds, tones, spoken words and/or other vocal, musical, instrumental and/or computer-generated audible expressions.

As employed herein, the term “video signal” shall expressly include, but not be limited by, any analog and/or digital representation of a plurality of still and/or moving images.

As employed herein, the term “music video” shall expressly include, but not be limited by, any prerecorded analog and/or digital representation of a plurality of musical sounds, musical tones and/or other musical and/or other audible artistic expressions in combination with a plurality of still and/or moving images.

As employed herein, the term “radio station” shall expressly include, but not be limited by, an FM radio station, an AM radio station, a satellite radio station and an Internet radio station.

As employed herein, the term “radio channel” shall expressly exclude a television channel and shall expressly include, but not be limited by, an FM radio channel, an AM radio channel, a satellite radio channel, an Internet radio channel and any suitable transmission path at particular frequencies and/or wavelengths over which radio waves and/or light including modulated audio signals are transmitted.

As employed herein, the term “television channel” shall expressly include, but not be limited by, a satellite television channel, a local, regional or national television channel, a cable television channel, a direct broadcast satellite television channel, either analog or digital, an Internet video channel and any suitable transmission path at particular frequencies and/or wavelengths over which radio waves and/or light including modulated audio and video signals are transmitted.

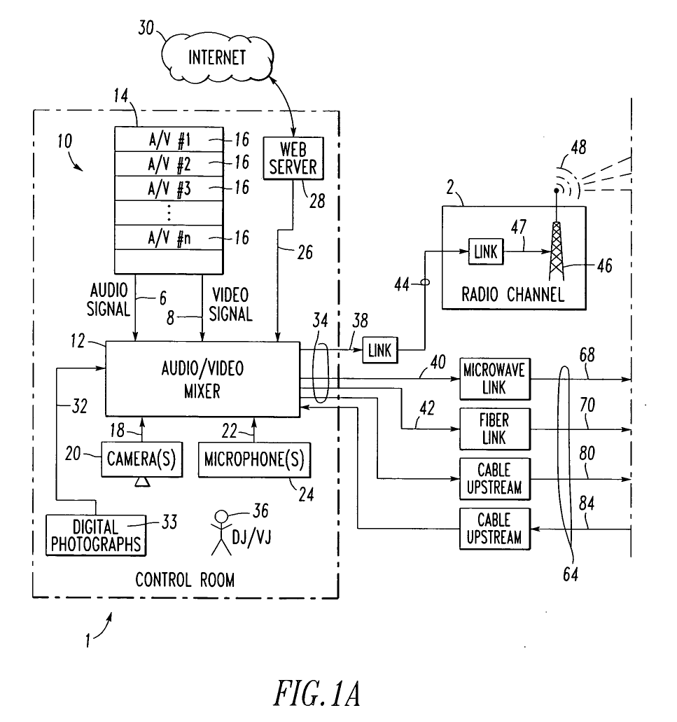

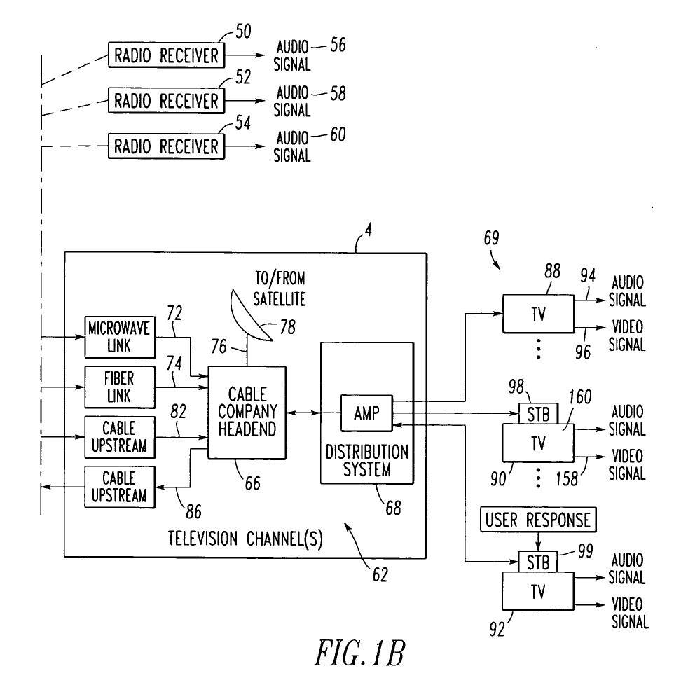

Referring to FIGS. 1A-1B, a radio station 1 employs a radio broadcast on a radio channel 2 and a contemporaneous television broadcast on a cable television channel 4 in accordance with the invention. This is one example of a system that provides a method of transmitting an audio signal 6 and a video signal 8. The method transmits the audio signal 6 from one or more prerecorded audio/video sources 10 over the radio channel 2. Furthermore, with respect to that audio signal transmission, the method contemporaneously transmits the audio signal 6 and the video signal 8 from the one or more prerecorded audio/video sources 10 over the television channel 4.

FIG. 1A shows an example of the radio station 1, which includes a suitable audio/video mixer 12 that receives a number of different audio and video signals from various sources. For example, the audio signal 6 and the video signal 8 are input to the mixer 12 from a suitable storage mechanism, such as hard drive 14, including a number of audio/video files 16 (e.g., A/V #1; A/V #2; A/V #3; A/V #N; one or more music videos). Another video signal 18 is input to the mixer 12 from one or more video cameras 20. Another audio signal 22 is input to the mixer 12 from one or more microphones 24. A wide range of additional audio and/or video signals may also be employed. For example, audio and/or video signals, such as 26, may be input to the mixer 12 from a web server 28 that receives such signals from the Internet 30. As another example, a video signal, such as 32, may be input to the mixer 12 from a suitable source including one or more digital photographs 33.

The mixer 12 may operate in one or more of a manual operating mode, a semi-automatic operating mode and an automatic operating mode. In the manual operating mode, the selection of the audio and/or video outputs 34 from the mixer 12 is under the control of an operator, such as the example disk jockey/video jockey (DJ/VJ) 36. In the automatic operating mode, the selection of the audio and/or video outputs 34 from the mixer 12 is under the control of a suitable processor (not shown). In the semi-automatic operating mode, the selection of the audio and/or video outputs 34 from the mixer 12 is under the control of the processor and the DJ/VJ 36.

Although one mixer 12 is shown for both of the radio and television channels 2,4, it will be appreciated that the mixer 12 may include a first mixer for the radio channel 2 and a second mixer for the television channel 4.

The audio and/or video outputs 34 include an audio output 38 and one or more audio/video outputs 40,42. The audio output 38 is sent to the radio channel 2 by a suitable link 44, such as, for example, a studio transmitter link (STL), a microwave communication channel or a fiber optic communication channel. The example radio channel 2 includes a conventional broadcast tower 46, which receives an audio output 47 from the link 44 and broadcasts radio frequency signals 48 (e.g., FM radio; AM radio) to a wide range of different radio receivers 50,52,54, which permit a wide range of listeners (not shown) to receive the respective audio signals 56,58,60. It will be appreciated, however, that the radio channel 2 is not limited to FM or AM radio broadcasts and may include any suitable radio channel, such as, for example, any suitable radio transmissions through a wide range of satellite radio station channels and/or Internet radio station channels.

The one or more television channels 4 are provided, in this example, by a suitable cable television system 62 that includes one or more links 64 to the radio station 1, a headend 66, a distribution system 68 and a plurality of subscriber drops 69. The headend 66 is a signal reception and processing center that collects, organizes and distributes signals from a wide range of different sources. The links 64 may include, for example, one or more links to the radio station mixer 12, such as, for example, a microwave link 68 and/or a fiber optic link 70. Those links, in turn, output audio/video signals 72 and/or 74, respectively, to the headend 66. As another example, an audio/video signal 76 may be received from or sent to a satellite (not shown) by a satellite dish 78. As a further example, a cable upstream link 80 from the radio station mixer 12 provides another audio/video signal 82. Another cable upstream link 84 to the radio station mixer 12 provides another audio/video signal 86 from the headend 66.

The distribution system 68 carries various signals from the headend 66 to (or from) a number of distribution points, such as, for example, the subscriber drops 69, which include, for example, a wide range of different television receivers (TVs) 88,90,92, which permit a wide range of listener/viewers (not shown) to receive signals, such as the audio signal 94 and the video signal 96 as shown with the TV 88. Some of the televisions, such as 90,92, include respective set-top boxes (STBs) 98,99.

It will be appreciated, however, that the television channel 4 is not limited to cable television and may include any suitable television channel, such as, for example, a satellite television channel, a local, regional or national television channel, a direct broadcast satellite television channel, either analog or digital, or an Internet video channel.

In addition to the example of the cable television channel(s) 4 of FIG. 1B, a wide range of different television distribution platforms and/or technologies may be employed by the invention. These platforms and technologies are discussed below in connection with Examples 1-5.

### EXAMPLE 1

As one example alternative to the example cable television channel(s) 4, a direct broadcast satellite (DBS) may be employed to provide cable-like television programming on one or more channels directly from satellites to relatively small satellite dishes. For example, two DBS companies include DIRECTV and EchoStar with their services called DIRECTV® and DISH®, respectively.

### EXAMPLE 2

Digital Television (DTV) is a relatively new type of broadcasting technology that allows broadcasters to offer television with movie-quality picture and CD-quality sound, along with a variety of other enhancements. DTV technology can also be used to transmit large amounts of other data into the home, which may be accessible by using a computer or a television set. For example, both High Definition TV (HDTV) and Standard Definition TV (SDTV) are transmitted using DTV technology. HDTV is a high-resolution picture which is digitally broadcast to compatible home television sets. SDTV is a relatively lower resolution picture than HDTV. For example, broadcasters may be able to either digitally broadcast four or more SDTV services at the same time, or a single HDTV service. Some broadcasters also employ multicasting with a high definition feed on a primary sub-channel and a normal standard definition feed on a secondary sub-channel. Hence, other alternatives to the cable television channel(s) 4 include a DTV HDTV channel or sub-channel and a DTV SDTV channel or sub-channel.

### EXAMPLE 3

It is known to provide WiFi-enabled televisions or television signals through WiFi (e.g., On-Air Entertainment; T-Mobile; Wayport).

For example, in the not-so-distant future, people will use wireless networks to transfer television, videos, music and digital photographs to computers and entertainment devices around the house. Businesses will also employ wireless networks for high quality voice and video communications.

This provides another alternative to the cable television channel(s) 4 as might be employed, for example, at an airport, a coffee shop or any suitable place where persons may gather.

### EXAMPLE 4

As another alternative to the cable television channel(s) 4, a television channel may direct its feed to a web site for access over the Internet. See, for example, the web site at http://www.webtvlist.com/, which provides a list of television stations transmitting on the Internet.

### EXAMPLE 5

As yet another alternative to the cable television channel(s) 4, a mobile telephone or a suitable wireless device, such as, for example, a high speed wireless Internet platform, may soon be capable of receiving, in addition to video, low grade video or high grade streaming video, television-like signals including audio and video transmitted on various wireless channels.

The example radio channel 2 and cable television channel(s) 4 of FIGS. 1A-1B or the alternative channels of Examples 1-5, above, provide a wide range of synergies for revenue enhancement that were not possible without the invention. These synergies are discussed below in connection with Examples 6-14.

### EXAMPLE 6

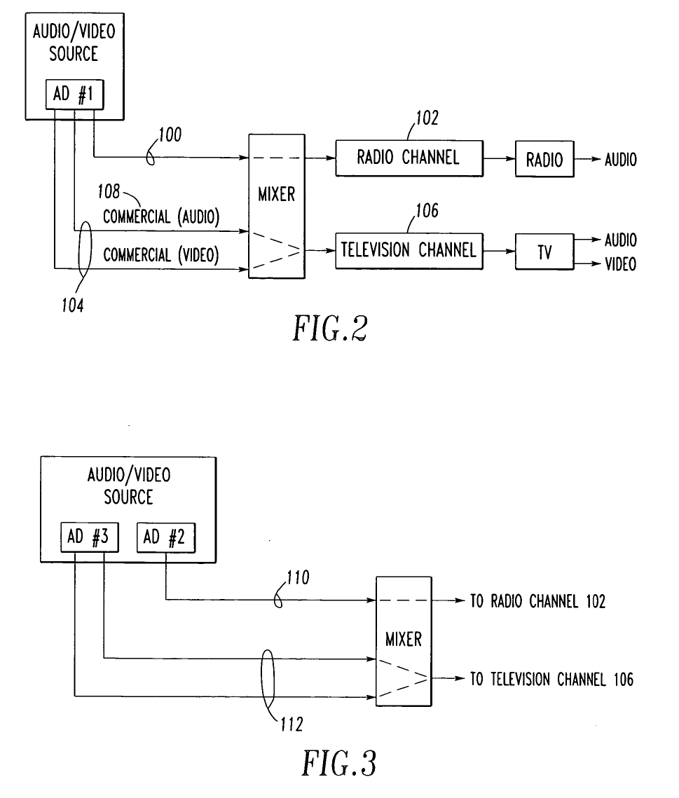

As shown in FIG. 2, an audio advertisement 100 on the radio channel 102 may be supplemented by a contemporaneous video and/or audio advertisement 104 on the television channel 106. This allows the entity paying for the audio advertisement 100 to “supersize” the advertising order with, for example, the combination of both of the audio and audio/video advertisements 100,104. This increases the revenue stream to the proprietor of the radio and television channels 102,106. In this example, the audio portion 108 of the video and/or audio advertisement 104 is the same as the audio of the audio advertisement 100, although those audio portions may be substantially similar, similar or different.

### EXAMPLE 7

As an alternative to Example 6, as shown in FIG. 3, the available advertising inventory can effectively be doubled, with corresponding increases in total advertising revenues, by transmitting separate and different, non-simulcast radio (audio 110) and television (audio and/or video 112) advertisements (e.g., commercials).

### EXAMPLE 8

As another alternative to Example 6, where a radio (audio) broadcast is originated remotely from the radio station 1 of FIG. 1A at, for example, a remote retail establishment (e.g., a two hour broadcast from a car dealer) (not shown) in consideration for suitable advertising payments, that remote broadcast can be supplemented, along with the advertising payments, by providing a contemporaneous audio/video broadcast by the television channel, such as 106 of FIG. 2.

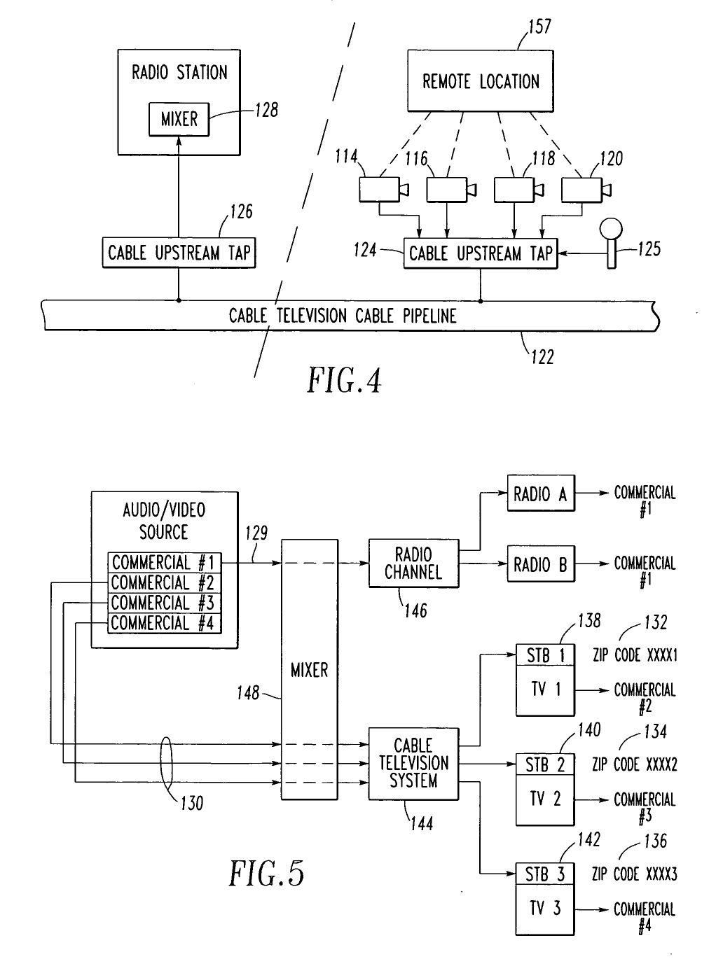

For example, as shown in FIG. 4, the remote video (and/or audio) feeds can be provided from one or more fixed cameras 114, hand held cameras 116, mini-cams 118 and/or helmet cams 120 by tapping into a local cable television cable pipeline 122 and employing the cable upstream feature. A suitable channel from the cable upstream is provided by tap 124 to receive the remote video (and/or audio 125) feeds and provide the same by tap 126 to the radio station mixer 128.

Alternatively, suitable video signals (not shown) to the mixer 128 may be provided through a satellite telephone, a spread spectrum wireless frequency, or a suitable future cellular or mobile telephone that supports such video signals.

### EXAMPLE 9

Traditional radio broadcasts have often included audio “call-ins” (e.g., 60-second spots) from a remote disk jockey (DJ) in the field (e.g., at a live concert) (not shown). The audio signal for such “call-ins” may be supplemented with a video signal, for example, in the same manner as was discussed above in connection with Example 8. This adds visual elements to the contemporaneous television broadcast that were not available with the audio-only radio broadcast.

### EXAMPLE 10

Conventional radio broadcasting does not support targeted advertising by zip code since the same audio signal is broadcast to the entire listening area. For example, various different radio broadcasts may reach tens, hundreds or thousands of different zip codes. Hence, audio advertisements, such as 129 of FIG. 5, over known conventional radio channels, such as 146, cannot be targeted based upon selected demographic and psychographic listener information that is correlated to one or more zip codes.

However, as shown in FIG. 5, three contemporaneous, but different, television advertisements 130 may be directed to one or more selected zip codes 132,134,136, since, for example, the respective set top boxes 138,140,142 of the cable television system 144 are addressable. Numerous cable television companies permit advertisements to be directed to specific zip codes. In contrast, the conventional radio “broadcast” channel, such as 146, cannot perform this “narrowcast” channel function.

FIG. 5 shows the various advertisements 129,130 feeding the radio station mixer 148. Alternatively, at a radio station, such as the radio station 1 of FIG. 1A, a suitable automation system (not shown) would indicate by a suitable digital signal (not shown) to the cable television system 144 that it is time to insert the “narrowcast” commercials and the traffic software (not shown) at the cable television system 144 determines which of one or more commercials, such as 130, to send to the respective one or more “narrowcast” zip codes 132,134,136. Although each of the commercials 130 is associated with a corresponding one of the zip codes 132,134,136, multiple zip codes or other suitable geographic regions may be employed.

As another alternative, different television advertisements can be directed to different cable carriers (not shown) who serve different geographic areas (e.g., different zip codes; a city and its different suburbs).

### EXAMPLE 11

As a more specific example for Example 10, radio advertisements, such as 129 of FIG. 5, may be economical for certain small and localized businesses (e.g., pizza shops), while general television advertisements, such as 130, are relatively more expensive. However, by targeting the television advertisements 130 to one or more particular zip codes, such as 132,134,136, both the radio advertisement 129 and the targeted zip code television advertisements 130 may be affordable to such small and localized businesses.

### EXAMPLE 12

As a more specific example for Example 10, tags (e.g., the end of an advertisement for a business having a plurality of locations, such as, for example, a car dealership having seven different locations throughout a city) can be customized by zip code. Hence, a general advertisement is transmitted to all of the relevant zip codes, such as 132,134,136, while each of the customized tags is sent to the particular zip code(s) corresponding to the appropriate locations of, for example, the car dealership. Hence, a viewer in, for example, zip code xxxx1 132 sees the information for the local car dealer for that zip code 132 in the corresponding end tag and is not confused by listings for the other six car dealers in different zip codes, such as 134,136, around the example city.

### EXAMPLE 13

A premium membership club may be established for viewers of the cable television channel 4 of FIG. 1B. This may have the attributes of a frequent flyer program or a viewer club, such that viewers can obtain discounts, such as retail discounts, at participating businesses.

### EXAMPLE 14

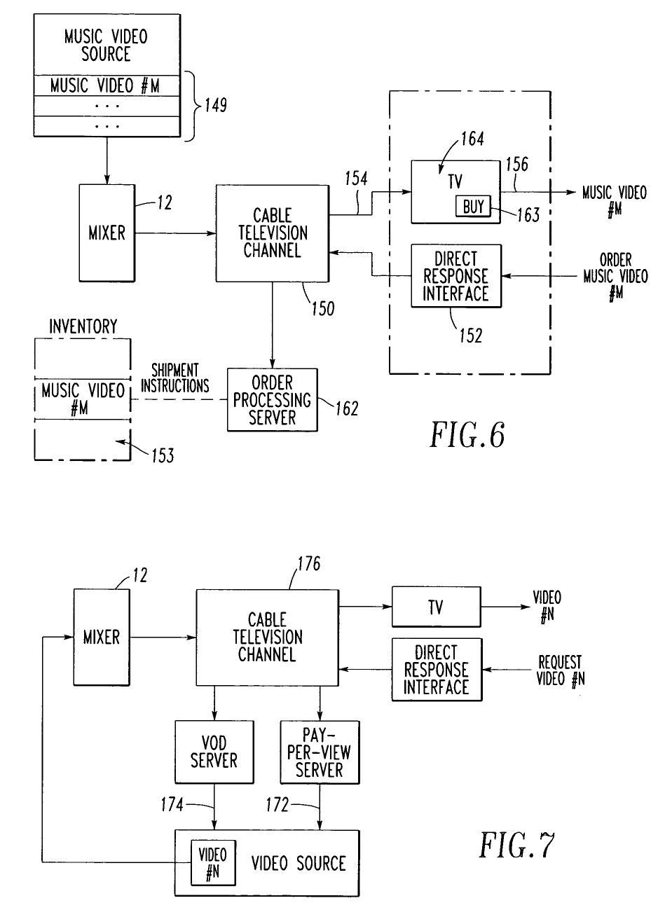

As shown in FIG. 6, in conjunction with the broadcast of the music videos 149 on the cable television channel 150, a suitable direct response interface 152 provides the viewer with the opportunity to purchase a wide range of goods and/or services 153 (e.g., without limitation, CDs; DVDs; downloads; digital copies of music videos; video ring tones; conventional ring tones, t-shirts; merchandise; concert tickets; backstage passes) on the cable 154 or through a secondary wireless data device (not shown). For example, a suitable set top box, such as 98,99 of FIG. 1B, may be connected to a home computer (not shown) or an in-house wireless network (not shown). In other words, the viewer/consumer can click a button (not shown) and order anything they see or hear on the cable television channel 150.

For example, a suitable discount off of the normal purchase price for the good or service may be provided to the viewer/consumer if the purchase is made during the broadcast of the corresponding music video 156.

### EXAMPLE 15

As an alternative to the example prerecorded audio/video files 16 (e.g., music videos) of FIG. 1A, the audio signal 6 and the video signal 8 may originate from a number of different sources. For example, audio and video signals may be recorded live, be delayed and then be broadcast. Alternatively, the audio and video signals may be recorded live, be suitably edited, be delayed and then be broadcast.

As one example, the radio and television channels 2,4 of FIGS. 1A-1B may contemporaneously broadcast a concert on a delayed basis.

As another example, a “DVD listener show” may be recorded live, be later edited and/or be delayed, and then be broadcast with or without live elements. Also, the same or different DJ/VJ personalities may be heard and seen on both the radio and television channels 2,4.

The example radio channel 2 and cable television channel 4 of FIGS. 1A-1B or the alternative channels of Examples 1-5, above, provide a wide range of enhancements for the listeners of the radio channel 2 that were not possible without the invention. These enhancements are discussed below in connection with Examples 16-23.

### EXAMPLE 16

Increased “remote audience” (e.g., listeners of the radio channel 2 of FIG. 1A; listener/viewers of the cable channel(s) 4; others that attend a remote broadcast) interaction may be provided by one or more live cameras (e.g., cameras 114,116,118,120 of FIG. 4) at one or more remote locations (e.g., at a mall; at a concert), such as 157 of FIG. 4. Remote audio and/or video signals from those remote locations may be input to the radio station mixer 128, for example, in the same manner as was discussed above in connection with Example 8.

### EXAMPLE 17

Live video feeds of traffic problems (e.g., from a traffic cam) or of the weather (e.g., from a weather cam from the roof of a building) add a visual element to a traffic report or a weather report, respectively. These remote video feeds may be provided by one or more live cameras (e.g., cameras 114,116,118,120 of FIG. 4) at one or more remote locations, such as 157 of FIG. 4. The video signals may be input to the radio station mixer 128, for example, in the same manner as was discussed above in connection with Example 8.

As another example, for interactive television services, the listener/viewer may select one of several remote video feeds to pick the appropriate traffic cam for display, in order to view the traffic conditions of interest to that listener/viewer.

### EXAMPLE 18

Different types of contests may be provided by the radio station 1 that were not possible with an audio-only broadcast. For example, such contests may be directed toward only the viewers of the television channel 4 of FIG. 1B. For example, the viewer may be prompted to call-in to the radio station 1 when the viewer sees something (e.g., a “red dot”) in the video signal 158 on the television screen 160. As another example, contest instructions or information suggesting that a viewer should call-in to the radio station 1 are shown on the television channel 4, but no corresponding audio instructions are provided on the radio channel 2.

### EXAMPLE 19

A local live request show (e.g., similar to the TRL (i.e., Total Request Live) television show on the MTV channel) where the remote audience (e.g., at a mall; at a remote studio; at the local studio) takes the place of a DJ/VJ and initiates requests for the different music videos to be broadcast. These audio/video feeds may be provided by one or more cameras (e.g., cameras 114,116,118,120 of FIG. 4) at one or more local or remote locations, such as 157 of FIG. 4. The remote audio/video signals may be input to the radio station mixer 128, for example, in the same manner as was discussed above in connection with Example 8.

As another example, instead of the remote audio/video signals, video signals corresponding to text messaging from cell phones (not shown) may be employed. Hence, those text messages may be broadcast as part of the television video signal, such as 158 of FIG. 1B.

### EXAMPLE 20

Remote audio interviews (e.g., with celebrities; sport stars; news makers) may be supplemented with video. These video feeds may be provided by one or more cameras (e.g., cameras 114,116,118,120 of FIG. 4) at one or more remote locations, such as 157 of FIG. 4. The video signals may be input to the radio station mixer 128, for example, in the same manner as was discussed above in connection with Example 8.

### EXAMPLE 21

As an expansion of Example 9, “roadshow” broadcasts may be provided from one or more special events (e.g., the Country Music Awards; the Grammy Awards; a charitable event, such as the St. Jude's Radiothon) (not shown). The audio/video signals may be provided in a suitable manner or in the same manner as was discussed above in connection with Example 8. This adds visual elements to the contemporaneous audio/video television broadcast that were not available with the audio-only radio broadcast.

### EXAMPLE 22

There exists the ability to send data in a wide range of formats over cable channels. As a variation of Example 14, for example, this data might be in the form of an MP3 that the viewer/listener orders from the cable television channel 150 of FIG. 6 and is downloaded directly to a user interface, such as the direct response interface 152. In this example, the system of product ordering may be where a cable company, such as the cable television channel 150, has an interactive ordering system in place, such as the order processing server 162. The consumer watches (and listens to) a music video, such as 149, sees a “buy it” button 163 on his/her television screen 164 and clicks that button from the interface 152. The user may then download, for example, a digital music MP3, a digital video MP4 file, an off-the-shelf DVD of the particular music video 149, and/or a custom DVD of one or more previously broadcast music videos from the inventory of goods and/or services 153.

### EXAMPLE 23

Listeners/viewers may send in digital photographs, such as 33 of FIG. 1A, to the radio station 1 through conventional cellular telephone channels. Those digital photographs 33, in turn, are input by the mixer 12 and are broadcast to the cable television channel 4.

For example, the web server 28 of FIG. 1A may have a telephone number or Internet web address that the listener/viewer would access and then download his/her digital photograph 33. The producer at the radio station 1 would access the digital photograph 33 from the web server 28 and add the same to the on-air video product, such as the video signal 158. The digital photograph 33 may then be displayed as image 166 in window 167 of FIG. 9. Rather than a “cellular telephone check in” to a conventional radio station, this would provide the function of a “camera phone check in”. Hence, this merges audio/video cellular telephone users with both radio and television broadcasts.

### EXAMPLE 24

Although FIG. 1A shows a conventional radio channel 2, a satellite radio channel on cable may be employed (e.g., XM Satellite Radio; Sirius Satellite Radio). For example, an audio feed for an XM popular music channel may be supplemented by an audio/video feed to a corresponding television channel. Furthermore, some or all of the different music channels (e.g., classical; hard rock; punk rock) on the satellite radio channel may be supplemented by corresponding contemporaneous television channels, such as 4, including the corresponding audio/video signals 72 or 74.

As another alternative, a cable network may operate independently of any radio station and may employ one or more combinations of radio channels (e.g., without limitation, cable; satellite) and cable television channels. There can be, for example, a first cable radio channel, another radio channel on satellite or cable, and a national brand pop music channel, each of which generates their own programming including, for example, local brands, live interaction and/or national feeds.

### EXAMPLE 25

In addition to Example 24, there may be breaks in the audio (satellite radio) and audio/video (cable television) broadcasts for advertisements. Such advertisements may be national advertisements or local advertisements (e.g., as was discussed above in connection with Examples 10-12).

### EXAMPLE 26

As an alternative to the radio station 1 and prerecorded audio/video files 16 (e.g., music videos) of FIG. 1A, the radio station 1 may be a news/talk radio station and the hard drive 14 may include prerecorded news videos, prerecorded news clips and/or prerecorded news/talk show programs (e.g., locally identifiable hosts; Lars Larson on KXL, Portland; Rusty Humphries on KVI, Seattle). This provides news or talk radio being broadcasted on the radio channel 2 with callers providing the content and/or being supplemented by news clips and/or other suitable different video being contemporaneously broadcasted on the television channel 4.

As another example, similar to Example 23, for news/talk or call-in/talk shows, a listener/viewer may send a live streaming picture 168 of them self when he/she calls in to a talk show. In turn, the news/talk radio station takes the live stream 168 and includes it as a window 169 of FIG. 10 of the broadcast background video signal 170. Hence, other listeners/viewers see the caller in the window 168 talking to the host of the program as shown by the background video signal 170.

### EXAMPLE 27

As shown in FIG. 7, on-demand video, such as pay-per-view video 172 and video-on-demand (VOD) 174, is not live and is not synchronized or contemporaneous with the corresponding live radio channel broadcast from the radio channel 2 of FIG. 1A.

For example, one cable video-on-demand channel 176 might playback at a later time or a later date than a radio station's morning or afternoon or evening show. For example, an archive of the audio and video signals from such shows may be recorded, be stored, and then be recalled by subsequent video-on-demand requests.

### EXAMPLE 28

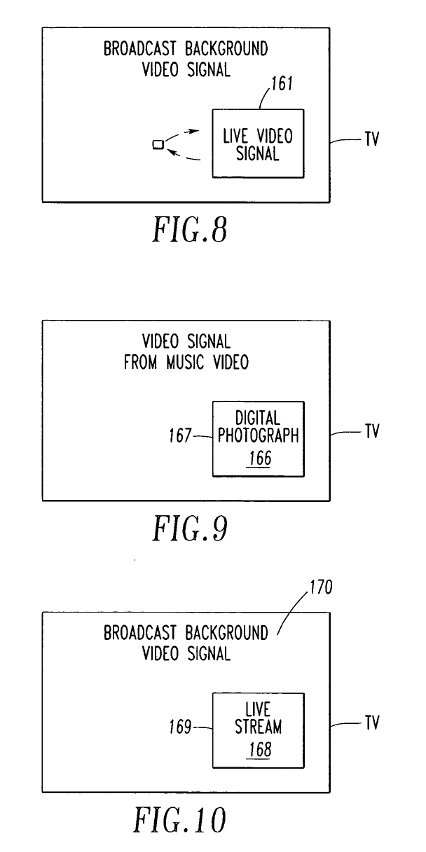

As shown in FIG. 8, a live video signal, as might be provided in connection with any of Examples 8, 9, 16, 17, 19, 20 or 21, or from the radio station 1 of FIG. 1A, may be shown in a window 161. For example, that window 161 might be displayed at the conclusion of one of the audio/video files 16 and might be reduced to nothing at the start of another one of those files 16.

The disclosed invention provides a wide range of results that are not expected from a radio channel, such as 2 of FIG. 1A. As but a few examples, these results may include unexpected increases in listeners to the radio station 1, unexpected increases in advertising revenue to the radio station 1 resulting from the contemporaneous transmitting of the audio and video signals 6,8 from prerecorded audio/video sources 16, such as music videos, to the television channel 4, and the sales of, for example, goods and/or services, such as CDs, DVDs, MP3s and/or MP4s for the music videos. There may also be unexpected increases in advertising revenue to the radio station 1 resulting from the contemporaneous transmitting of the audio and video signals 6,8 from the prerecorded audio/video sources 16 to the television channel 4.

It will be appreciated that the radio and television channels 2,4 of FIGS. 1A-1B may employ a combination of one or more of analog, digital and/or processor-based circuits.

While for clarity of disclosure reference has been made herein to the example television screens, such as 160,164, for displaying television video signals, it will be appreciated that such signals may be stored, be printed on hard copy, be computer modified, or be combined with other data. All such processing shall be deemed to fall within the terms “display” or “displaying” as employed herein.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A method of transmitting audio and video signals, said method comprising:
transmitting an audio signal from at least one music video over a radio channel; and
with respect to said transmitting an audio signal, contemporaneously transmitting said audio signal and a video signal from said at least one music video over a television channel.

2. The method of claim 1 further comprising
originating said audio signal and said video signal from a radio station; and
employing as said radio station one of an FM radio station, an AM radio station, a satellite radio channel on cable, and an Internet radio station.

3. The method of claim 1 further comprising
employing as said television channel one of a satellite channel, a local, regional or national television channel, a cable channel and a direct broadcast satellite channel.

4. The method of claim 1 further comprising
employing as said television channel one of a digital television high definition television channel or sub-channel and a digital television standard definition television channel or sub-channel.

5. The method of claim 1 further comprising
transmitting an audio advertisement over said radio channel; and
contemporaneously transmitting an audio and video advertisement over said television channel.

6. The method of claim 5 further comprising
employing substantially identical audio portions of said audio advertisement and said audio and video advertisement.

7. The method of claim 5 further comprising
employing as said video advertisement a first video commercial;
employing a second different video commercial;
directing said first video commercial to a first zip code; and
directing said second different video commercial to a second different zip code.

8. The method of claim 1 further comprising
originating said audio signal and said video signal from a radio station;
receiving a live video signal at said radio station;
temporarily including a window in the video signal of said television channel; and
including said live video signal in said window.

9. The method of claim 8 further comprising
including a disk jockey or video jockey in said live video signal.

10. The method of claim 8 further comprising
employing a size of said window; and
reducing the size of said window to zero as one of said at least one music video starts.

11. The method of claim 8 further comprising
employing a size of said window; and
increasing the size of said window as one of said at least one music video ends.

12. The method of claim 1 further comprising
originating said audio signal and said video signal from a radio station; and
recording said at least one music video on a disk drive at said radio station.

13. The method of claim 1 further comprising
employing as said at least one music video a prerecorded audio signal and a prerecorded video signal from a live performance;
transmitting said prerecorded audio signal over said radio channel; and
with respect to said transmitting said prerecorded audio signal, contemporaneously transmitting said prerecorded audio signal and said prerecorded video signal over said television channel.

14. The method of claim 1 further comprising
employing as said at least one music video a prerecorded audio signal and a prerecorded video signal from a live performance;
editing said prerecorded audio signal and said prerecorded video signal;
transmitting said edited prerecorded audio signal over said radio channel; and
with respect to said transmitting said edited prerecorded audio signal, contemporaneously transmitting said edited prerecorded audio signal and said edited prerecorded video signal over said television channel.

15. The method of claim 14 further comprising
including live elements with said edited and prerecorded audio and video signals over said television channel.

16. The method of claim 1 further comprising
originating said audio signal and said video signal from a radio station;
receiving a digital photograph at said radio station;
temporarily including a window in the video signal of said television channel; and
including said digital photograph in said window.

17. A method of transmitting audio and video signals, said method comprising:
transmitting an audio signal from at least one prerecorded audio/video source over a radio channel; and
with respect to said transmitting an audio signal, contemporaneously transmitting said audio signal and a video signal from said at least one prerecorded audio/video source over a television channel.

18. The method of claim 17 further comprising
employing as one of said at least one prerecorded audio/video source a music video.

19. The method of claim 17 further comprising
employing as one of said at least one prerecorded audio/video source a prerecorded news or talk radio program including said audio signal and said video signal.

20. A method of transmitting audio and video signals, said method comprising:
recording audio and video signals from at least one audio/video source;
transmitting an audio signal from said recorded audio and video signals over a radio channel; and
with respect to said transmitting an audio signal, transmitting said audio signal and a video signal from said recorded audio and video signals on a contemporaneous or delayed basis from said recorded audio and video signals over a television channel.

21. The method of claim 20 further comprising
receiving a video-on-demand request after said transmitting an audio signal from said recorded audio and video signals over a radio channel; and
responsively transmitting audio and video signals from said recorded audio and video signals over said television channel.

22. The method of claim 20 further comprising
receiving a pay-per-view request after said transmitting an audio signal from said recorded audio and video signals over a radio channel; and
responsively transmitting audio and video signals from said recorded audio and video signals over said television channel.

23. The method of claim 20 further comprising
with respect to said transmitting an audio signal, transmitting said audio and video signals on a contemporaneous basis from said recorded audio and video signals over said television channel.
